(19) United States
(12) Patent Application Publication
(10) Pub. No.: US 2023/0420723 A1
(43) Pub. Date: Dec. 28, 2023

(54) BATTERY AND DEVICE COMPRISING SAME

(71) Applicant: Ningde Amperex Technology Limited, Ningde (CN)

(72) Inventors: Kun YAN, Ningde (CN); Zhonghuang XU, Ningde (CN)

(73) Assignee: Ningde Amperex Technology Limited, Ningde (CN)

(21) Appl. No.: 18/466,948

(22) Filed: Sep. 14, 2023

Related U.S. Application Data
(63) Continuation of application No. PCT/CN2021/080845, filed on Mar. 15, 2021.

(51) Int. Cl. H01M 10/04; H01M 4/75; H01M 50/124; H01M 50/119; H01M 50/121; H01M 50/105

(52) U.S. Cl. CPC H01M 10/0431; H01M 4/75; H01M 50/105; H01M 50/119; H01M 50/121; H01M 50/124

(57) ABSTRACT

An electrode assembly includes a first electrode plate, a separator, and a second electrode plate that are disposed in a stack. The first electrode plate and the second electrode plate respectively have coating areas and empty foil areas arranged at intervals. Centers of the coating areas overlap each other to form a coating portion of the electrode assembly, and centers of the empty foil areas overlap each other to form a flexible portion of the electrode assembly. The first packaging layer coats the coating portion and the flexible portion of the electrode assembly, and the second packaging layer at least coats the first packaging layer on the flexible portion.

### CROSS-REFERENCE TO RELATED APPLICATION

This application is a continuation of International Patent Application No. PCT/CN2021/080845, filed on Mar. 15, 2021, the disclosure of which is hereby incorporated by reference in its entirety.

### TECHNICAL FIELD

The present application relates to the technical field of batteries, and in particular, to a battery having flexibility and a device comprising same.

### BACKGROUND

In current research on flexible batteries, electrode plates of comb tooth structures are often wound around the same electrical connector to form a vertebral column battery, or a plurality of cells are connected in parallel through electrical connection into one cell, both cases enabling a cell to have a feature of local flexibility at a connection position and to be applicable to intelligent wearable products. However, the above two modes typically have the following problems in manufacturing and use processes: (1) As the number of cells increases, the difficulty in synchronous winding of the cells increases, leading to low production efficiency. The existing vertebral column battery is formed by performing die cutting on an entire electrode plate to produce a plurality of comb tooth structures, with each electrode plate being wound separately into a cell along an end thereof. A larger number of comb teeth results in a more complex winding process, which leads to lower efficiency. (2) During a bending process of a flexible battery, a rigid battery body is prone to damage, causing safety issues such as performance degradation and short circuits. (3) Due to the impacts of a required thickness and bending radius of the cell, the conventional aluminum plastic film encapsulation material has a short bending fatigue life, thus affecting a battery service life.

### SUMMARY

In view of above, it is necessary to provide a novel flexible battery to solve the problems of damage likely occurring on a cell body of the flexible battery and a short bending fatigue life of an encapsulation material, in order to improve the safety and service life of the battery.

The technical solution of the present application is: a battery, including: an electrode assembly, a first packaging layer, and a second packaging layer. The electrode assembly includes a first electrode plate, a separator, and a second electrode plate that are disposed in a stack, the first electrode plate and the second electrode plate being spaced apart from each other by the separator. The first electrode plate has a first coating area and a first empty foil area arranged at intervals, the second electrode plate has a second coating area and a second empty foil area arranged at intervals, the first coating area and the second coating area overlap each other to form a coating portion of the electrode assembly, and the first empty foil area and the second empty foil area overlap each other to form a flexible portion of the electrode assembly. The first packaging layer coats the coating portion and the flexible portion of the electrode assembly, and the second packaging layer at least coats the first packaging layer on the flexible portion.

The first electrode plate and the second electrode plate in the present application each have a coating area and an empty foil area that are strip-shaped and arranged at intervals. After stacking, since a thickness of the empty foil area is less than that of the coating area, layers of the empty foil area are not bonded or in contact with each other after the coating area is pressed, but form a layered structure. That is, the first electrode plate, the separator, and the second electrode plate at a position of the flexible portion are independent of each other, and impose no impact on each other during a bending process, which is equivalent to bending a plurality of thin layers, thus reducing a section modulus in bending. Moreover, due to the presence of interlayer gaps, there are spaces for accommodating deformations of the first electrode plate, the separator, and the second electrode plate during the bending process, thereby effectively reducing a risk of a relatively short service life due to a relatively large stress caused by bending and stretching.

The first packaging layer in the present application has high rigidity. When the flexible portion is bent, the first packaging layer has a relatively large stress and thus is prone to damage, which may cause a liquid leakage. Coating a surface layer of the first packaging layer with the second packaging layer can effectively improve stress concentration caused by the bending of the first packaging layer at the position of the flexible position. Meanwhile, the second packaging layer can absorb part of the stress and homogenize the stress, thereby further improving a bending fatigue life of the battery.

In an implementation, the battery further includes a protective housing, the protective housing being disposed between the first packaging layer and the electrode assembly and coating the coating portion. In an implementation, the protective housing is disposed between the first packaging layer and the second packaging layer and coats the coating portion. In an implementation, the protective housing coats at least three of four surfaces of the coating portion. In an implementation, at least two coating portions are provided.

The protective housing mainly functions to support and enhance the strength of the coating portion, such that a significant strength difference is present between the flexible portion and the coating portion of the battery, making it very easy to bend the battery at the position of the flexible portion having low rigidity during use. Meanwhile, due to the presence of the protective housing, damage to the coating portion caused by bending or twisting during extreme use can be reduced significantly, thus reducing a risk of active substance detachment.

In an implementation, a material of the protective housing includes at least one of engineering plastic, bakelite, fiberglass, stainless steel, and titanium alloy. The engineering plastic includes at least one of acrylonitrile-butadiene-styrene (ABS) (terpolymer of three monomers: acrylonitrile (A), butadiene (B), and styrene (S)), polypropylene (PP), polyvinyl chloride (PVC), polyphenylene ether (PE), polystyrene (PS), polybutylene terephthalate (PBT), polytetrafluoroethylene (PTFE), polyethylene terephthalate (PET), and recycled polyethylene terephthalate (RPET).

In an implementation, a material of the second packaging layer includes at least one of injection-molded rubber and injection-molded expanded material. The injection-molded rubber includes at least one of silicone rubber, ethylene propylene diene monomer rubber, butadiene rubber, styrene butadiene rubber, isoprene rubber, and fluororubber. The injection-molded expanded material includes at least one of pearl cotton or expandable polyethylene (EPE), expanded polypropylene (EPP) plastic expanded material, expanded polyvinyl chloride (EPVC) resin, ethylene-vinyl acetate (EVA) copolymer, expanded polystyrene (EPS), expanded ethylene propylene diene monomer rubber, expanded styrene butadiene rubber, expanded chloroprene rubber, expanded silicone rubber, and expanded fluororubber.

The present application further provides a device, wherein the device includes the battery as described above as a power supply.

The battery provided by the present application and the device including the battery have simple structures, greatly reducing the manufacturing difficulty. The use of the rigid protective housing for coating the coating portion composed of electrode plate coating areas reduces the bending of the coating portion during use of the battery, preventing active substance detachment from the coating portion and thereby improving the safety. The use of the second packaging layer for coating the flexible portion composed of electrode plate empty foil areas reduces the bending stress of the flexible portion, thereby improving the service life of the product.

### BRIEF DESCRIPTION OF DRAWINGS

The present application is further described below in detail in conjunction with the drawings and specific implementations.

FIG. 1 is a structural schematic diagram of an electrode assembly provided in an embodiment of the present application.

FIG. 2 is a schematic diagram of a first electrode plate provided in an embodiment of the present application.

FIG. 3 is a schematic diagram of a second electrode plate provided in an embodiment of the present application.

FIG. 4 is a structural schematic diagram of a flexible portion in FIG. 1.

FIG. 5 is a structural schematic diagram of a cell obtained by coating the electrode assembly in FIG. 1 with a first packaging layer.

FIG. 6 is a structural schematic diagram of the cell in FIG. 5 coated with a protective housing.

FIG. 7 is a structural schematic diagram of a battery provided in Embodiment 1 of the present application.

FIG. 8 is a structural schematic diagram of a battery provided in Embodiment 2 of the present application.

FIG. 9 is a structural schematic diagram of a battery provided in Embodiment 3 of the present application.

### REFERENCE SIGNS OF MAIN COMPONENTS

10. Electrode assembly
30. First packaging layer
50. Second packaging layer
70. Protective housing
90. Wiring terminal
101. First electrode plate
102. Second electrode plate
103. Separator
104. Coating portion
105. Flexible portion
106. First electrode tab
107. Second electrode tab
1011. First coating area
1012. First empty foil area
1013. First current collector
1014. First active substance layer
1021. Second coating area
1022. Second empty foil area
1023. Second current collector
1024. Second active substance layer

Embodiments of the present application will be further described below in conjunction with specific implementations and drawings.

### DETAILED DESCRIPTION

Unless otherwise defined, all technical and scientific terms used herein have the same meanings as those commonly understood by a person skilled in the technical field to which the embodiments of the present application pertain. The terms used herein are only for the purpose of describing the specific implementations and are not intended to limit the embodiments of the present application.

It should be noted that all directional indications (such as upper, lower, left, right, front, rear, . . . ) in the embodiments of the present application are only used to explain relative position relationships, motion situations, etc. between components in a specific posture (as shown in the drawings). If the specific posture changes, the directional indications also change accordingly.

In addition, in this application, descriptions relating to “first”, “second”, etc. are only for descriptive purposes and cannot be understood as indicating or implying relative importance or implying the number of indicated technical features. Therefore, the features defined by “first” and “second” can explicitly or implicitly include at least one of these features. In the description of the present application, “a plurality of” refers to at least two objects, such as two, three, etc. objects, unless otherwise specified.

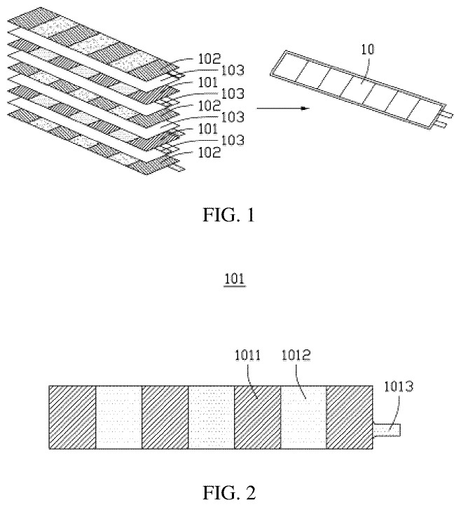

The present application provides a battery, which includes an electrode assembly, a first packaging layer, and a second packaging layer. Referring to FIG. 1, the electrode assembly 10 includes a first electrode plate 101, a separator 103, and a second electrode plate 102 that are disposed in a stack, the first electrode plate 101 and the second electrode plate 102 being spaced apart from each other by the separator 103. FIG. 1 shows a case where an outer layer electrode plate is the second electrode plate 102, with the number of layers corresponding to the second electrode plate 102 is n (n is an integer and n≥2), and the number of layers corresponding to the first electrode plate 101 of the other polarity is n−1. It can be understood that when the electrode plate disposed in an outer layer is the first electrode plate 101, the number of layers of the first electrode plate 101 is n (n is an integer and n≥2), and the number of layers of the second electrode plate 102 is n−1.

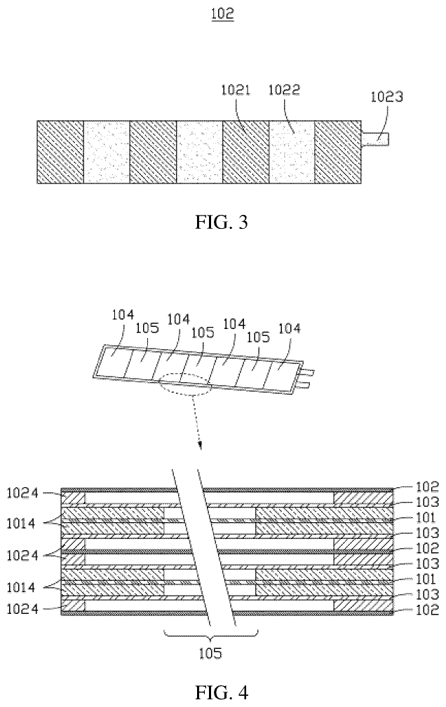

Referring to FIG. 2, the first electrode plate 101 has a first coating area 1011 and a first empty foil area 1012 arranged at intervals, and the first electrode plate 101 is provided with a first current collector 1013 at an end thereof. Referring to FIG. 3, the second electrode plate 102 has a second coating area 1021 and a second empty foil area 1022 arranged at intervals, and the second electrode plate 102 is provided with a second current collector 1023 at an end thereof. Further, a length of the first coating area 1011 (in an extension direction of the electrode plate) is slightly greater than a length of the second coating area 1021, a width of the first coating area 1011 is slightly greater than a width of the second coating area 1021, and a length and a width of the separator 103 are slightly greater than a length and a width of the first electrode plate 101 respectively.

Referring to FIG. 1 and FIG. 4, the first coating area 1011 and the second coating area 1021 overlap each other to form a coating portion 104 of the electrode assembly 10, and the first empty foil area 1012 and the second empty foil area 1022 overlap each other to form a flexible portion 105 of the electrode assembly 10. In this implementation, a center of the first coating area 1011 and a center of the second coating area 1021 overlap each other, and a center of the first empty foil area 1012 and a center of the second empty foil area 1022 overlap each other. Further, after being stacked, the first electrode plate 101, the separator 103, and the second electrode plate 102 undergo cold pressing/hot pressing or compression during a formation stage, so that the first coating area 1011 and the second coating area 1021 of each layer can be in effective contact, thus forming the coating portion 104. The number of the coating portions 104 is m, and m is an integer and m≥2.

Referring to FIG. 4, a surface layer of the electrode assembly 10 is a single-face coated second electrode plate 102, and the second electrode plate 102 is coated with a second active substance layer 1024 in the second coating area 1021 near a surface of the separator 103. It can be understood that the surface layer of the electrode assembly 10 can also be a single-face coated first electrode plate 101, and the first electrode plate 101 is coated with a first active substance layer 1014 in the first coating area 1011 near the surface of the separator 103. Except for the first electrode plate 101 or the second electrode plate 102 on the surface layer being single-face coated, the first electrode plate 101 and the second electrode plate 102 inside the electrode assembly 10 are both double-face coated, that is, the first coating areas 1011 on upper and lower surfaces of the first electrode plate 101 are both coated with the first active substance layers 1014, and the second coating areas 1021 on upper and lower surfaces of the second electrode plate 102 are both coated with the second active substance layers 1024. The centers of the second coating area 1021 of each second electrode plate 102 and the first coating area 1011 of each first electrode plate 101 are disposed opposite each other, and the first coating area 1011 protrudes slightly relative to the second coating area 1021 in both length and width directions.

Further, since the first active substance layer 1014 and the second active substance layer 1024 for single-face coating or double-face coating have specific thicknesses, a thickness of the coating portion 104 is greater than a thickness of the adjacent flexible portion 105. After the cold pressing/hot pressing or the compression under pressure during the formation stage, empty foil areas of all electrode plates are not bonded or in contact with each other, but form a layered structure without interlayer adhesion as shown in FIG. 4. In the flexible portion 105, the first electrode plate 101, the separator 103, and the second electrode plate 102 are independent of each other and have interlayer gaps. All components impose no impact on each other during a bending process of the flexible portion 105, which is equivalent to bending a plurality of independent layers separately, thus reducing a section modulus in bending, reducing a stress of the flexible portion 105 during bending, and thereby improving the flexibility of the flexible portion 105. Moreover, due to the presence of the interlayer gaps, there are spaces for accommodating deformations of the first electrode plate 101 and the second electrode plate 102 during the bending process, thereby effectively reducing a risk of a relatively short service life of the electrode plate caused by a relatively large stress during bending and stretching processes.

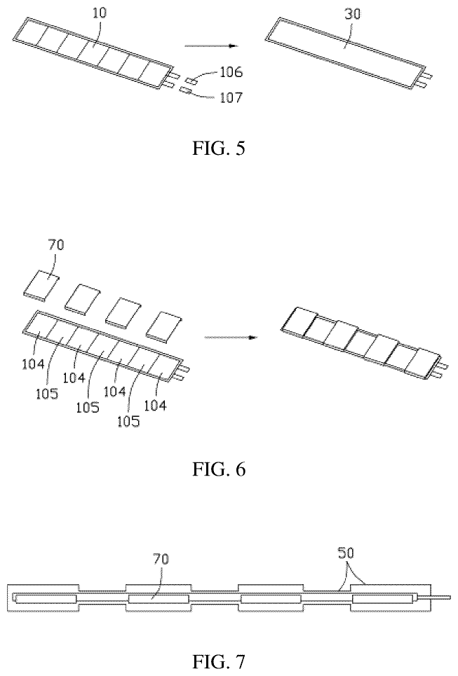

Referring to FIG. 5, a plurality of layers of first current collectors 1013 stacked are welded with a first electrode tab 106, and a plurality of layers of second current collectors 1023 stacked are welded with the second electrode tab 107. The first electrode tab 106 and the second electrode tab 107 are both provided with polypropylene (PP) sealants to form good sealing with the first packaging layer 30. In this implementation, the first electrode tab 106 is an anode electrode tab, and the second electrode tab 107 is a cathode electrode tab. Furthermore, the first packaging layer 30 coats the coating portion 104 and flexible portion 105 of the electrode assembly 10. In this implementation, a material of the first packaging layer 30 is an aluminum plastic film. In some implementations, top sealing and side sealing are carried out at 170-185° C., and side sealing is further performed after liquid injection. The coating portion 104 and the flexible portion 105 of the electrode assembly 10 are fully sealed, and a cell is prepared after processes such as standing and formation.

Referring to FIG. 6, at a corresponding position of each coating portion 104 on an outer side of the first packaging layer 30, a protective housing 70 is attached and mounted using an adhesive, so as to coat the coating portion 104. The protective housing 70 coats at least three of four surfaces of the coating portion 104. The protective housing 70 mainly functions to support and enhance the strength of the coating portion 104, such that a significant strength difference is present between the flexible portion 105 and the coating portion 104 of the battery, making it very easy to bend the battery at the position of the flexible portion 105 having low rigidity during use. Meanwhile, due to the presence of the protective housing 70, damage to the coating portion 104 caused by bending or twisting during extreme use can be reduced significantly, thus reducing a risk of active substance detachment. It can be understood that the protective housing 70 can also be disposed between the electrode assembly 10 and the first packaging layer 30, i.e., disposed on an inner side of the first packaging layer 30. The protective housing 70 in FIG. 6 is U-shaped, can cover both side faces and one of upper and lower surfaces of each coating portion 104, and slightly protrudes relatively to the coating portion 104 in length and width directions, i.e., fully covers the coating portion 104 to enhance the rigidity of the coating portion 104. Further, a material of the protective housing includes at least one of engineering plastic, bakelite, fiberglass, stainless steel, and titanium alloy. The engineering plastic includes at least one of acrylonitrile-butadiene-styrene (ABS) (terpolymer of three monomers: acrylonitrile (A), butadiene (B), and styrene (S)), polypropylene (PP), polyvinyl chloride (PVC), polyphenylene ether (PE), polystyrene (PS), polybutylene terephthalate (PBT), polytetrafluoroethylene (PTFE), polyethylene terephthalate (PET), and recycled polyethylene terephthalate (RPET).

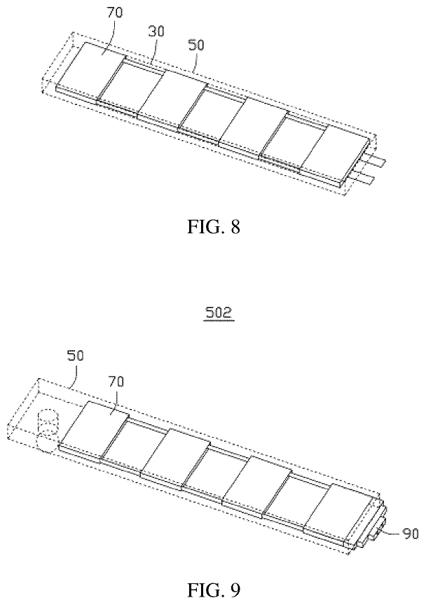

Referring to FIG. 7, the battery provided in an implementation of the present application further includes a second packaging layer 50. The second packaging layer 50 at least coats the first packaging layer 30 on the flexible portion 105. It can be understood that when the battery includes the second packaging layer 50 and the protective housing 70 is disposed on the outer side of the first packaging layer 30, the protective housing 70 is disposed between the first packaging layer 30 and the second packaging layer 50. Further, the second packaging layer 50 needs to at least cover upper and lower surfaces and two side faces of the flexible portion 105, and the upper and lower surfaces and two side faces of the coating portion 104 can be coated partially or fully according to an actual situation. Meanwhile, the flexible portion 105 can be encapsulated into different shapes according to actual needs, e.g., can be encapsulated into a structure with upper and lower grooves as shown in FIG. 7, can be encapsulated into a straight form as shown in FIG. 8 and FIG. 9, and can also be encapsulated into a form having grooves on a single face.

Further, a material of the second packaging layer includes at least one of injection-molded rubber and injection-molded expanded material. The injection-molded rubber includes at least one of silicone rubber, ethylene propylene diene monomer rubber, butadiene rubber, styrene butadiene rubber, isoprene rubber, and fluororubber. The injection-molded expanded material includes at least one of pearl cotton or expandable polyethylene (EPE), expanded polypropylene (EPP) plastic expanded material, expanded polyvinyl chloride (EPVC) resin, ethylene-vinyl acetate (EVA) copolymer, expanded polystyrene (EPS), expanded ethylene propylene diene monomer rubber, expanded styrene butadiene rubber, expanded chloroprene rubber, expanded silicone rubber, and expanded fluororubber. The flexible portion 105 has a relatively long bending fatigue life due to the good flexibility of the material of the second packaging layer 50. Meanwhile, due to the support and protection effects of the rigid protective housing 70, the overall rigidity of the coating portion 104 is greater than the rigidity of the flexible portion 105, causing the battery to spontaneously and selectively bend at the position of the flexible portion 105 during use. The coating portion 104 is subjected to no stress or subjected to a relatively small stress, thus having relatively high safety. Moreover, since the first packaging layer 30 has relatively high rigidity, the first packaging layer 30 has a relatively large stress when the flexible portion 105 is bent, resulting in an insufficient bending fatigue life. During bending, the first packaging layer 30 at the position of the flexible portion 105 is prone to damage, which may cause a liquid leakage. Coating a surface layer of the first packaging layer 30 with the second packaging layer 50 can effectively improve stress concentration caused by the bending of the first packaging layer 30 at the position of the flexible position 105, and can absorb part of the stress and homogenize the stress, thereby further improving a bending fatigue life of the battery.

The present application also provides a device, wherein the device includes the battery as described above as a power supply.

The present application is further described below in conjunction with specific embodiments.

### Embodiment 1

FIG. 7 is a structural schematic diagram of a battery provided in this embodiment.

Firstly, corresponding electrode materials are applied on foils respectively by means of a zebra coating process and applied into stripes arranged at intervals, so as to obtain corresponding first electrode plate coil and second electrode plate coil, which are die-cut into single-layer first electrode plate 101 and second electrode plate 102 as shown in FIG. 2 and FIG. 3 using a cutting die. Similarly, a corresponding single-layer separator 103 is obtained by die-cutting. Further, a first coating area 1011 and a first empty foil area 1012 are disposed and arranged at intervals on the first electrode plate 101, and the first electrode plate 101 is provided, at an end thereof, with a first current collector 1013 obtained by die-cutting the foil of the first electrode plate 101. A second coating area 1021 and a second empty foil area 1022 are disposed and arranged at intervals on the second electrode plate 102, and the second electrode plate 102 is provided, at an end thereof, with a second current collector 1023 obtained by die-cutting the foil of the second electrode plate 102. Further, a length and a width of the first coating area 1011 are slightly greater than a length and a width of the second coating area 1021 respectively, and a length and a width of the separator 103 are slightly greater than a length and a width of the first electrode plate 101 respectively. In this embodiment, the first electrode plate 101 is an anode electrode plate, and the second electrode plate 102 is a cathode electrode plate.

Then, referring to FIG. 1, the second electrode plate 102, the separator 103, and first electrode plate 101 are stacked in a corresponding sequence to form a multi-layer stacked electrode assembly 10. A surface layer of the electrode assembly 10 is a single-face coated second electrode plate 102, and the first electrode plate 101 and the second electrode plate 102 inside the electrode assembly 10 are both double-face coated. The separator 103 is disposed between the adjacent second electrode plate 102 and first electrode plate 101. Centers of the second coating area 1021 of each second electrode plate 102 and the first coating area 1011 of each first electrode plate 101 are disposed opposite each other (overlap), and the first coating area 1011 protrudes slightly relative to the second coating area 1021 in both length and width directions. The first coating area 1011 and the second coating area 1021 are stacked to form a coating portion 104, and the first empty foil area 1012 and the second empty foil area 1022 are stacked to form a flexible portion 105. Further, a partially enlarged diagram of the flexible portion 105 is as shown in FIG. 4. Since flexible portion 105 has a thickness less than a thickness of the adjacent coating portion 104, the first electrode plate 101, the separator 103, and the second electrode plate 102 in the flexible portion 105 are independent of each other without contact, with all layers being independent of each other during a bending process, which is equivalent to bending a plurality of thin layers, thus reducing a section modulus in bending. As such, the flexible portion 105 has relatively high flexibility and a relatively small stress.

Next, the stacked multi-layer first current collector 1013 is welded with a first electrode tab 106, and the stacked multi-layer second current collector 1023 is welded with a second electrode tab 107. The first electrode tab 106 and the second electrode tab 107 are both provided with a polypropylene (PP) sealant to form good seal with a first packaging layer 30. In this embodiment, the first electrode tab 106 is an anode electrode tab, and the second electrode tab 107 is a cathode electrode tab. In this embodiment, a material of the first packaging layer 30 is an aluminum plastic film. In some implementations, top sealing and side sealing are carried out at 170-185° C., and side sealing is further performed after liquid injection. The coating portion 104 and the flexible portion 105 of the electrode assembly 10 are fully sealed, and a cell is prepared after processes such as standing and formation.

Then referring to FIG. 6, at a corresponding position of each coating portion 104 on an outer side of the aluminum plastic film, a protective housing 70 is attached and mounted using an adhesive, so as to coat the coating portion 104. In this embodiment, a material of the protective housing 70 is stainless steel. The protective housing 70 is U-shaped, covers both side faces and one of upper and lower surfaces of the coating portion 104, and slightly protrudes relatively to the coating portion 104 in length and width directions, thus fully covering the coating portion 104 to enhance the rigidity of the coating portion 104.

Finally, referring to FIG. 7, the entire surface layer is coated with a second packaging layer 50, which is designed to be a form with upper and lower grooves at a position of each flexible portion 105, so as to facilitate positioning and use in terminal products. A material of the second packaging layer 50 is a hot-melt polyolefin elastomer (POE). The final battery only has only two electrode tabs penetrating through the second packaging layer 50 to be exposed for connection with an electrical element.

### Embodiment 2

FIG. 8 is a structural schematic diagram of a battery provided in this embodiment.

Different from Embodiment 1, a material of a protective housing 70 in this embodiment is polypropylene (PP) with good insulation and electrolyte resistance, and the protective housing 70 is disposed inside a first packaging layer 30 (i.e., disposed between an electrode assembly 10 and the first packaging layer 30) and coats a coating portion 104. In this embodiment, a material of the first packaging layer 30 is also an aluminum plastic film, top sealing and side sealing are carried out at 170-185° C., and side sealing is further performed after liquid injection. A cell is prepared after processes such as standing and formation.

In addition, different from Embodiment 1, a second packaging layer 50 of a material of silicone rubber is provided on an entire surface layer of the cell, and the second packaging layer 50 has no recess at a position of a flexible portion 105, but is encapsulated in a straight form structure. The silicone rubber has a relatively long bending fatigue life at the position of the flexible portion 105 due to the excellent flexibility thereof. Meanwhile, due to support and protection effects of the rigid protective housing 70, the overall rigidity of the coating portion 104 is greater than the rigidity of the flexible portion 105, causing the battery to spontaneously and selectively bend at the position of the flexible portion 105 during use. The coating portion 104 is subjected to no stress or subjected to a relatively small stress, thus having relatively high safety.

### Embodiment 3

FIG. 9 is a structural schematic diagram of a flexible watchband battery provided in this embodiment.

In this embodiment, a protective housing 70 of a material of polypropylene (PP) is disposed at a corresponding position of each coating portion 104 on an outer side of an aluminum plastic film. The protective housing 70 fully coats upper and lower faces and two side faces of the coating portion 104, and at least one inner surface of the protective housing 70 is fixed to the aluminum plastic film at a corresponding position using glue.

Different from Embodiment 1 and Embodiment 2, in this embodiment, an end of the battery is also connected to a wiring terminal 90. A material of a second packaging layer 50 is low-temperature molded fluororubber, and the second packaging layer 50 is directly molded into a watchband shape. As such, the second packaging layer 50 not only can functions to homogenize a stress to protect a flexible portion 105, but also can directly function as a watchband for application in terminal electronic products, eliminating an assembly process during an application process.

The battery provided by the present application and the device including the battery have simple structures, greatly reducing the manufacturing difficulty. The use of a rigid protective housing for coating the coating portion composed of electrode plate coating areas reduces the bending of the coating portion during use of the battery, preventing active substance detachment from the coating portion and thereby improving the safety. The use of the second packaging layer for coating the flexible portion composed of electrode plate empty foil areas reduces the bending stress of the flexible portion, thereby improving the service life of the product.

What is claimed is:

1. A battery, comprising:
an electrode assembly, a first packaging layer, and a second packaging layer;
the electrode assembly comprising a first electrode plate, a separator, and a second electrode plate disposed in a stack, the separator being disposed between the first electrode plate and the second electrode plate;
the first electrode plate has at least two first coating areas and at least one first empty foil area, wherein one first empty foil area is disposed between two adjacent first coating areas;
the second electrode plate has at least two second coating areas and at least one second empty foil area, wherein one second empty foil area is disposed between two adjacent second coating areas;
the at least two first coating areas and the at least two second coating areas overlap each other to form a coating portion of the electrode assembly;
the at least one first empty foil area and the at least one second empty foil area overlap each other to form a flexible portion of the electrode assembly;
the first packaging layer is coated on the coating portion and the flexible portion of the electrode assembly; and
the second packaging layer is coated on at least the first packaging layer on the flexible portion.

2. The battery according to claim 1, further comprising a protective housing, the protective housing being disposed between the first packaging layer and the electrode assembly; and the protective housing coats the coating portion.

3. The battery according to claim 1, wherein the battery further comprises a protective housing, the protective housing being disposed between the first packaging layer and the second packaging layer; and the protective housing coats the coating portion.

4. The battery according to claim 2, wherein the protective housing coats at least three surfaces of the coating portion.

5. The battery according to claim 4, wherein a material of the protective housing comprises at least one selected from the group consisting of engineering plastic, bakelite, fiberglass, stainless steel, and titanium alloy.

6. The battery according to claim 5, wherein the material of the protective housing comprises the engineering plastic; the engineering plastic comprises at least one selected from the group consisting of acrylonitrile-butadiene-styrene terpolymer, polypropylene, polyvinyl chloride, polyphenylene ether, polystyrene, polybutylene terephthalate, polytetrafluoroethylene, polyethylene terephthalate, and recycled polyethylene terephthalate.

7. The battery according to claim 1, wherein a material of the second packaging layer comprises at least one selected from the group consisting of an injection-molded rubber and an injection-molded expanded material.

8. The battery according to claim 7, wherein the material of the second packaging layer comprises the injection-molded rubber; and the injection-molded rubber comprises at least one selected from the group consisting of silicone rubber, ethylene propylene diene monomer rubber, butadiene rubber, styrene butadiene rubber, isoprene rubber, and fluororubber.

9. The battery according to claim 7, wherein the material of the second packaging layer comprises the injection-molded expanded material; and the injection-molded expanded material comprises at least one selected from the group consisting of pearl cotton, expanded polypropylene plastic expanded material, expanded polyvinyl chloride resin, ethylene-vinyl acetate copolymer, expanded polystyrene, expanded ethylene propylene diene monomer rubber, expanded styrene butadiene rubber, expanded chloroprene rubber, expanded silicone rubber, and expanded fluororubber.

10. A device, wherein the device comprises the battery according to claim 1.

11. The device according to claim 10, further comparing a protective housing, the protective housing being disposed between the first packaging layer and the electrode assembly; and the protective housing coats the coating portion.

12. The device according to claim 10, wherein the battery further comprises a protective housing, the protective housing being disposed between the first packaging layer and the second packaging layer; and the protective housing coats the coating portion.

13. The device according to claim 10, wherein the protective housing coats at least three surfaces of the coating portion.

14. The device according to claim 10, wherein a material of the protective housing comprises at least one selected from the group consisting of engineering plastic, bakelite, fiberglass, stainless steel, and titanium alloy.

15. The device according to claim 10, wherein the material of the protective housing comprises the engineering plastic; the engineering plastic comprises at least one selected from the group consisting of acrylonitrile-butadiene-styrene terpolymer, polypropylene, polyvinyl chloride, polyphenylene ether, polystyrene, polybutylene terephthalate, polytetrafluoroethylene, polyethylene terephthalate, and recycled polyethylene terephthalate.

16. The device according to claim 10, wherein a material of the second packaging layer comprises at least one selected from the group consisting of an injection-molded rubber and an injection-molded expanded material.

17. The device according to claim 16, wherein the material of the second packaging layer comprises the injection-molded rubber; and the injection-molded rubber comprises at least one selected from the group consisting of silicone rubber, ethylene propylene diene monomer rubber, butadiene rubber, styrene butadiene rubber, isoprene rubber, and fluororubber.

18. The device according to claim 16, wherein the material of the second packaging layer comprises the injection-molded expanded material; and the injection-molded expanded material comprises at least one selected from the group consisting of pearl cotton, expanded polypropylene plastic expanded material, expanded polyvinyl chloride resin, ethylene-vinyl acetate copolymer, expanded polystyrene, expanded ethylene propylene diene monomer rubber, expanded styrene butadiene rubber, expanded chloroprene rubber, expanded silicone rubber, and expanded fluororubber.
